(19) United States
(12) Patent Application Publication
(10) Pub. No.: US 2008/0244630 A1
(43) Pub. Date: Oct. 2, 2008

(54) Cooling and Selective Dust Shielding of Optical Pick-Up Unit in Dvd Disc Drive

(75) Inventors: Roland Arthur Van Es, Waalre (NL); Gerardus J.C. Van Miert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronic, N.V., Eindhoven (NL)

(21) Appl. No.: 10/597,177

(22) PCT Filed: Jan. 14, 2005
(86) PCT No.: PCT/IB05/50165

§ 371 Date: Jul. 14, 2006

Related U.S. Application Data
(60) Provisional application No. 60/536,975, filed on Jan. 16, 2004.

(51) Int. Cl. G11B 33/14

(52) U.S. Cl. 720/649; 720/648

(57) ABSTRACT

A DVD data drive (2) includes a disc drive housing (4) that includes a DVD cartridge (16) and an optical pick-up unit (10) joined to the DVD cartridge (16) such that sensitive parts of the OPU (10) may extend within the DVD cartridge (16) and are shielded from the inner environment (6) of the disc drive housing (4). A fan (22) and air inlet provide (20) for cooling the OPU (10) and DVD cartridge (16) by the forced convection of unfiltered cooling air directed through the disc drive housing (4). The OPU (10) and DVD cartridge (16) are joined by a dust seal (30) that ensures that the cooling air directed through the disc drive housing (4) is shielded from sensitive parts of the OPU (10) which remains dust-free.

The present invention relates, most generally, to an optical disc drive. More particularly, the present invention relates to an apparatus and method for cooling the optical pick-up unit of an optical disc drive.

In the multimedia age, a DVD (digital video disc) disc drive is an indispensable device in personal computers, DVD players, DVD recorders and other DVD systems. The optical pick-up head of a DVD system includes an optical pick-up unit (OPU) that reads recorded information from the DVD or provides information that is recorded on the DVD. The OPU includes a laser and sensitive optical parts such as mirrors and lenses. It is important to maintain cool operating conditions for the laser. If the laser is not cooled, overheating can occur, degrading the laser. Moreover, when the laser is overheated, additional power is required to obtain the same light output and the additional power causes the laser to heat up and degrade further. This is especially true for red lasers and also true for Blu and InfraRed lasers.

It is also important to maintain the sensitive parts of the OPU in a dust-free condition. Dust contaminates the optical system of the OPU and acts as a gray filter. Moreover, when dust collects on the sensitive parts of the OPU, additional laser power is required to provide the same light output to insure proper recording of the disc, in order to overcome the optical loss due to the dust. The use of additional power is undesirable since it is generally advantageous to operate at low power levels and there is an upper limit to the maximum laser power useable in a particular OPU. The additional input power again causes the laser of the OPU to heat up and degrade further. As such, dust shielding is also critical in maintaining reliable performance and in assuring a long lifetime of the OPU and laser.

Conventional DVD data drives are available that include dust shielding around the entire drive to prevent dust from reaching the OPU. The dust shielding, however, precludes the optical pick-up unit from being cooled by air or another cooling medium from outside the disc drive. As a result, temperatures inside the dust-shielded drive can become very high, especially during DVD recording.

A shortcoming of conventional technology is therefore the tradeoff that exists between air cooling the OPU to maintain the laser at cool operating conditions, and shielding the sensitive parts of the OPU from contaminating air. The two approaches appear to be mutually exclusive in conventional systems and according to conventional methods.

It would therefore be desirable to provide a DVD data drive in which sensitive parts of the OPU are maintained in a dust-free condition while the OPU is cooled.

To achieve these and other objects and in view of its purposes, the present invention addresses the shortcomings of conventional DVD disc drive technology and provides an apparatus and method for cooling an OPU while shielding sensitive parts of the OPU from being contaminated with dust.

In one exemplary embodiment, the present invention provides a disc drive apparatus comprising a disc drive housing containing an OPU (optical pick-up unit) and a DVD cartridge. The OPU is joined to the DVD cartridge such that sensitive parts of the OPU are shielded from the interior environment of the disc drive housing.

In another exemplary embodiment, the present invention provides a disc drive apparatus comprising an optical pick-up unit joined to a DVD cartridge, wherein sensitive parts of the optical pick-up unit are at least partially surrounded by a dust shield and at least further parts of the optical pick-up unit are cooled by forced convection.

In yet another exemplary embodiment, the present invention provides a method for operating a DVD data drive. The method includes providing a disc drive housing containing an OPU (optical pick-up unit) and a DVD cartridge. The OPU is joined to the DVD cartridge such that sensitive parts of the OPU are shielded from the interior environment of the disc drive housing. The method further includes cooling the OPU by forced convection.

The present invention is best understood from the following detailed description when read in conjunction with the accompanying drawing. It is emphasized that, according to common practice, the various features of the drawing are not necessarily to scale. On the contrary, the dimensions of the various features are arbitrarily expanded or reduced for clarity. Like numerals denote like features throughout the specification and drawing. Included in the drawing are the following figures.

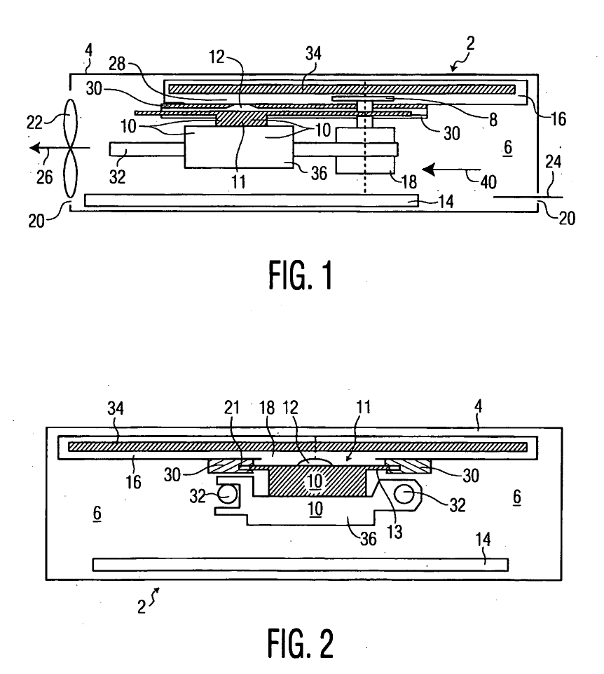

FIG. 1 is a side view of the interior of an exemplary disc drive according to the present invention;

FIG. 2 is a front view of the interior of the exemplary disc drive shown in FIG. 1;

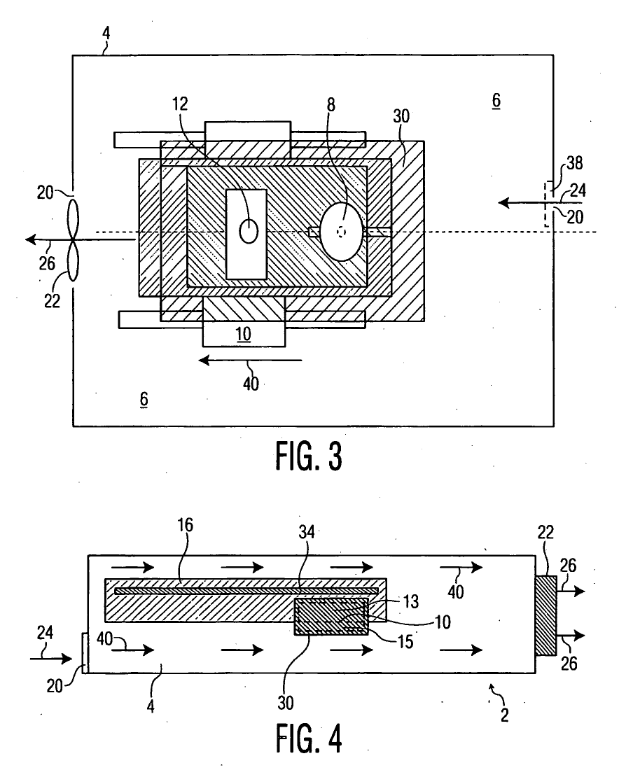

FIG. 3 is a top view of the interior of the disc drive shown in FIGS. 1 and 2; and

FIG. 4 is a side view of the interior of another exemplary embodiment of a disc drive of the present invention.

The present invention provides an apparatus and method for cooling an optical pick-up unit (OPU) disposed in a disc drive housing, using unfiltered air. Sensitive parts of the OPU are dust shielded.

FIG. 1 is a side view of various components in the interior of an exemplary DVD data drive shown in partial cross-section. FIG. 2 is a partial cross-sectional view of the interior of the exemplary disc drive shown in FIG. 1 and FIG. 3 is a top, cross sectional view of the interior of the exemplary disc drive shown in FIGS. 1 and 2, also in partial cross-section. The arbitrary designation of side, front, and top is for illustrative purposes only and to illustrate the relative position of the various components. This arbitrary designation is not intended to be limiting. The following description of this exemplary embodiment refers to the views shown in FIGS. 1, 2 and 3. Disc drive 2, also known as a DVD data drive, includes housing 4 which may be formed of suitable and conventional materials. In the illustrated embodiment, housing 4 contains drive PCB 14, OPU (optical pick-up unit) 10, turntable 8 and disc cartridge 16, in interior 6. Turntable 8 is coupled to turntable motor 18. In other exemplary embodiments, disc drive 2 may include further components but such further components are not illustrated for purposes of clarity.

In an exemplary illustrated embodiment shown most clearly in FIG. 2, shafts 32 align and fixedly position OPU 10 with respect to turntable motor 18, turntable 8, and disc cartridge 16 in the vertical direction and allow OPU 10, including portions 11 and 36 thereof, to slide along shafts 32, such that OPU 10 is translatable with respect to disc cartridge 16. Disc cartridge 16 contains disc 34 which may be a DVD or other optical disc upon which information is or may be stored. Disc cartridge 16 may be formed of plastic in one exemplary embodiment, but other suitable materials may be used in other exemplary embodiments. OPU 10 includes a variety of components used to read information from disc 34 or to record information onto disc 34. OPU 10 includes a laser such as a semiconductor or other laser, and various electrical and optical components such as optical components that guide the laser beam (not shown) onto the appropriate location on disc 34. For example, OPU 10 may include a plurality of sensitive component parts such as mirrors (not shown) and a lens system such as one that includes exemplary objective lens 12. The sensitive optical component parts such as objective lens 12 are generally positioned in portion 11 of OPU 10 that is proximate to disc cartridge 16. In another exemplary embodiment as will be shown in FIG. 4, a portion of OPU 10 may extend into disc cartridge 16. Portion 11 may be referred to as the actuator and generally contains the objective lens and sometimes a small flat plate that influences the polarization of the laser light. Further optical components are disposed in portion 36 of OPU 10, and are disposed outside, or relatively distally, with respect to disc cartridge 16.

Objective lens 12 is representative of the various sensitive components that are shielded from dust which may be present in the environment in interior 6, by means of dust shield 30 that seals OPU 10 to disc cartridge 16. Other sensitive parts such as light positioning/alignment parts such as further lenses and mirrors, as well as other electrical, optical and mechanical members, may be included among the sensitive parts shielded from the environment of interior 6 of housing 4. FIGS. 1 and 2 show this shielding most clearly. Dust shield 30 may be formed of plastic or other suitable materials. The further components in portion 36 are not shielded by dust shield 30 from the environment within interior 6. The further components in portion 36 may, for example, include various electrical components used to power the laser, and portions of the substrate upon or within which the laser is formed. OPU 10, disc cartridge 16 and dust shield 30 may be considered to form a subassembly that includes interior 28 which includes sensitive parts, is dust-free, and is shielded from the environment from interior 6 of housing 4 and therefore from air or any other cooling medium that may be directed through housing 4. OPU 10 is translatable with respect to dust shield 30 and disc cartridge 16 and in one exemplary illustrated embodiment of FIG. 2, OPU 10 may include lip 13 that slides within slot 21 of dust shield 30.

Fan 22 is used in conjunction with ports 20 of housing 4, to enable unfiltered air to be drawn into housing 4 to cool OPU 10, disc cartridge 16 and further components such as turntable motor 18 and drive PCB 14, by forced convection of unfiltered air that enters housing 4 as inlet air flow 24. Fan 22 may be a conventional fan powered by a conventional motor (not shown). A suitably small fan that can fit on a disc drive enclosure such as housing 4, may be used. Fan 22 is positioned to afford inlet air flow 24, into the interior 6 of housing 4. Internal air flow 40 cools the internal components of DVD data drive 2 including the further components within portion 36 of OPU 10 that are not shielded by dust shield 30. In one embodiment, portion 36 may include a casing formed of a suitable material such as metal, that allows the air or other cooling medium that flows through interior 6, to cool the further components in portion 36. In another exemplary embodiment, portion 36 may be covered by a casing and a metal dust cover. Outlet air flow 26 exits housing 4. Such cooling may advantageously take place during the operation of the disc drive, that is, when the laser of OPU 10 is powered so that OPU 10 reads recorded information from, or provides information that is recorded onto, disc 34.

In another exemplary embodiment, disc drive 2 may include optional air filter 38 illustrated only in ghost lines in FIG. 3. An advantage of the present invention, however, is that such a filter is not needed. The exemplary air flow illustrated in FIGS. 1-3 is intended to be exemplary only and in other exemplary embodiments, multiple ports or other openings may be used and positioned in various locations to provide for air flow throughout interior 6 in conjunction with fan 22 which may similarly be positioned variously with respect to housing 4.

In another exemplary embodiment, another cooling medium such as nitrogen may be used and may be directed through housing 4 using forced convection such as fan 22 shown in FIGS. 1-3 or another propulsion source may be used to direct a cooling medium through interior 6 of housing 4.

FIG. 4 is a cross-sectional and schematic side view of another exemplary DVD disc drive 2 in which OPU 10 extends partially within disc cartridge 16. In the illustration of FIG. 4, OPU 10 is positioned behind dust shield 30 and the outline of OPU 10 is indicated by the dashed lines. Inner portion 13 of OPU 10 is disposed within disc cartridge 16 and the sensitive optical parts (not shown) of OPU 10 are disposed within inner portion 13 of OPU 10 such that they are disposed within or at least extend into, disc cartridge 16. The subassembly of OPU 10, disc cartridge 16 and dust shield 30 has a dust free interior that is shielded from the environment of interior 6 of housing 4 and internal air flow 40 that cools disc cartridge 16 and OPU 10, particularly parts of OPU 10 located within outer portion 15 that is disposed outside of disc cartridge 16.

The preceding merely illustrates the principles of the invention. It will thus be appreciated that those skilled in the art will be able to devise various arrangements which, although not explicitly described or shown herein, embody the principals of the invention and are included within its spirit and scope. Furthermore, all examples and conditional language recited herein are principally intended expressly to be only for pedagogical purposes and to aid the reader in understanding the principals of the invention and the concepts contributed by the inventors to furthering the art, and are to be construed as being without limitation to such specifically recited examples and conditions. Moreover, all statements herein reciting principals, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawing, which are to be considered part of the entire written description. In the description, relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A disc drive apparatus comprising a disc drive housing (4) containing an OPU (optical pick-up unit) (10) and a DVD cartridge (16), said OPU (10) joined to said DVD cartridge (16) wherein sensitive parts of said OPU are shielded from an interior environment (6) of said disc drive housing.

2. The disc drive apparatus as in claim 1, further comprising said housing including at least a duality of openings (20) and a fan (26) that causes a cooling medium to flow through said housing (4) and cool at least one of said DVD cartridge (16) and said OPU (10).

3. The disc drive apparatus as in claim 2, wherein said cooling medium further cools further components including a turntable motor (18) and a disc drive PCB (14).

4. The disc drive apparatus as in claim 2, wherein said cooling medium comprises air.

5. The disc drive apparatus as in claim 4, wherein said air is unfiltered air.

6. The disc drive apparatus as in claim 1, wherein said sensitive parts are disposed at least partially within said DVD cartridge (16).

7. The disc drive apparatus as in claim 1, further comprising a dust seal (30) joining said OPU (10) and said DVD cartridge (16).

8. The disc drive apparatus as in claim 7, wherein said OPU (10) is translatable with respect to said DVD cartridge (16) and said dust seal (30).

9. The disc drive apparatus as in claim 7, wherein said OPU (10), DVD cartridge (16) and dust seal (30) form a subassembly including an enclosed interior (28) that contains said sensitive parts and is shielded from said interior environment (6).

10. The disc drive apparatus as in claim 9, further comprising said housing including at least a duality of openings (20) and a fan (22) that causes a cooling medium to flow through said housing (4) and wherein further parts of said OPU (10) are disposed outside said subassembly and within an OPU casing (36) that is directly cooled by said cooling medium.

11. The disc drive apparatus as in claim 10, wherein said further parts include electrical components and a laser.

12. The disc drive apparatus as in claim 1, wherein said sensitive parts comprise optical parts.

13. The disc drive apparatus as in claim 1, wherein said sensitive parts include at least one of a lens and a mirror.

14. The disc drive apparatus as in claim 1, wherein said OPU (10) is translatable with respect to said DVD cartridge (16).

15. The disc drive apparatus as in claim 1, wherein at least part of said OPU (10) and said DVD cartridge (16) are cooled by forced convection.

16. A disc drive apparatus comprising an optical pick-up unit (10) joined to a DVD cartridge (16), wherein sensitive parts of said optical pick-up unit (10) are at least partially surrounded by a dust shield (30) and at least further parts of said optical pick-up unit are cooled by forced convection.

17. The disc drive apparatus as in claim 16, further comprising a housing (4) encasing said DVD cartridge (16) and said optical pick-up unit (10) and a fan (22), said housing (4) including at least a duality of openings (20) that combine with said fan (22) to provide said forced convection.

18. The disc drive apparatus as in claim 16, in which said further parts are disposed within a casing (36) covered by a metal dust cover.

19. The disc drive as in claim 16, wherein said sensitive parts are disposed within an actuator section (11) of said optical pick-up unit (10) and said optical pick-up unit (10) is translatable with respect to said DVD cartridge (16) and said dust seal (30).

20. A method for cooling an OPU (optical pick-up unit) (10) disposed in a DVD data drive (2) and shielding said OPU (10) from dust, comprising:
providing a DVD cartridge (16), an OPU (10) and a disc drive housing (4);
joining said OPU (10) to said DVD cartridge (16) within said disc drive housing (4) wherein sensitive parts of said OPU are shielded from an interior environment (6) of said disc drive housing (4); and
cooling said OPU by forced convection.

21. The method as in claim 20 wherein said joining comprises using a dust seal (30) to join said OPU to said DVD cartridge wherein said OPU (10) is translatable with respect to said DVD cartridge (16).

22. The method as in claim 20, wherein said housing (4) includes at least a duality of openings (20) therethrough and said cooling comprising a fan (22) causing unfiltered air to flow through said disc drive housing (4).

23. A method for operating a DVD data drive (2) comprising:
providing a disc drive housing (4) containing an OPU (optical pick-up unit) (10) and a DVD cartridge (16), said OPU (10) joined to said DVD cartridge (16) wherein sensitive parts of said OPU (10) are shielded from an interior environment (6) of said disc drive housing (4); and
cooling said OPU (10) by forced convection.

24. The method as in claim 23, wherein said housing (4) includes at least a duality of openings (20) therethrough and said cooling comprising a fan (22) causing air to flow through said disc drive housing (4).

25. The method as in claim 23, wherein said cooling comprises cooling said OPU (10) and said DVD data drive (2) by forced convection of unfiltered air.

26. The method as in claim 23, wherein said cooling comprises powering a laser of said OPU (10) and cooling said laser.
